(19) United States
(12) Patent Application Publication
(10) Pub. No.: US 2025/0210277 A1
(43) Pub. Date: Jun. 26, 2025

(54) TANTALUM CAPACITOR

(71) Applicant: SAMSUNG ELECTRO-MECHANICS CO., LTD., Suwon-si (KR)

(72) Inventors: Yu Jin HAM, Suwon-si (KR); Boum Seock KIM, Suwon-si (KR); Chin Mo KIM, Suwon-si (KR); Jin Young KIM, Suwon-si (KR); Seong Jun PARK, Suwon-si (KR); Joung Hee CHO, Suwon-si (KR)

(73) Assignee: SAMSUNG ELECTRO-MECHANICS CO., LTD., Suwon-si (KR)

(21) Appl. No.: 18/971,661

(22) Filed: Dec. 6, 2024

(30) Foreign Application Priority Data
Dec. 26, 2023 (KR) 10-2023-0190732

(51) Int. Cl. H01G 9/052; H01G 9/008; H01G 9/04; H01G 9/08

(52) U.S. Cl. CPC H01G 9/052; H01G 9/008; H01G 9/08; H01G 2009/05

(57) ABSTRACT

A tantalum capacitor includes a tantalum body including a tantalum element body including tantalum particles and a conductive polymer layer disposed on the tantalum element body, the tantalum body having a first surface, a second surface opposing the first surface in a first direction, and a plurality of side surfaces connecting the first surface and the second surface to each other, a molded portion surrounding the tantalum body, and a coating layer disposed on at least a portion of an edge on which the first surface of the tantalum body and the plurality of side surfaces meet each other. When a thickness of an edge portion of the conductive polymer layer is denoted by t1 and a thickness of the coating layer is denoted by t2, a sum of t1 and t2 satisfies 5.5 μm or more and 100 μm or less.

### CROSS-REFERENCE TO RELATED APPLICATION(S)

This application claims benefit of priority to Korean Patent Application No. 10-2023-0190732 filed on Dec. 26, 2023 in the Korean Intellectual Property Office, the disclosure of which is incorporated herein by reference in its entirety.

### TECHNICAL FIELD

The present disclosure relates to a tantalum capacitor, more specifically, to a tantalum capacitor having improved reliability against stress and moisture resistance.

A tantalum (Ta) material is a metal widely used across industries, including in the electrical and electronics, machinery, chemical engineering, medical, aerospace, and defense industries, due to mechanical and physical characteristics thereof, such as high melting point, excellent ductility and corrosion resistance.

In particular, tantalum has been widely used as an anode material for small-sized capacitors due to characteristics thereof which form the most stable anodized film, among all metals.

Moreover, the use of a tantalum material has rapidly increased annually, due to the recent rapid development of IT industries, such as electronics, information and communication, and the like.

Tantalum capacitors may have a structure using an internal lead frame to connect a tantalum body and an electrode to each other. In this case, vapor pressure may permeate into a component through an interface between a lead frame and a molded portion in a high-temperature and humid environment, and internal stress may occur due to hygroscopic swelling and thermal expansion of an element.

### SUMMARY

An aspect of the present disclosure provides a tantalum capacitor having excellent reliability by strengthening an interface to lower a moisture absorption rate.

Another aspect of the present disclosure provides a tantalum capacitor having enhanced characteristics against stress.

According to an aspect of the present disclosure, there is provided a tantalum capacitor including a tantalum body including a tantalum element body including tantalum particles and a conductive polymer layer disposed on the tantalum element body, the tantalum body having a first surface, a second surface opposing the first surface in a first direction, and a plurality of side surfaces connecting the first surface and the second surface to each other, a molded portion surrounding the tantalum body, and a coating layer disposed on at least a portion of an edge on which the first surface of the tantalum body and the plurality of side surfaces meet each other. When a thickness of an edge portion of the conductive polymer layer is denoted by t1 and a thickness of the coating layer is denoted by t2, a sum of t1 and t2 may satisfy 5.5 μm or more and 100 μm or less.

According to example embodiments of the present disclosure, a tantalum capacitor may have excellent reliability by strengthening an interface to lower a moisture absorption rate.

According to example embodiments of the present disclosure, a tantalum capacitor may have enhanced characteristics against stress.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view of a tantalum capacitor according to the present disclosure;

FIG. 2 is a diagram illustrating a tantalum capacitor viewed in a third direction according to the present disclosure;

FIG. 3 is a perspective view of a tantalum body and a coating layer of a tantalum capacitor according to the present disclosure;

FIG. 4 is a cross-sectional view taken along line I-I′ of FIG. 1;

FIG. 5 is an enlarged view of portion “A” of FIG. 4;

FIG. 6 is a cross-sectional view taken along line II-II′ of FIG. 1;

FIG. 7 is a modification of a tantalum capacitor according to the present disclosure, and is a cross-sectional view corresponding to FIG. 3;

FIG. 8 is a modification of a tantalum capacitor according to the present disclosure, and is a cross-sectional view corresponding to FIG. 5; and

FIG. 9 is a cross-sectional view of a tantalum capacitor according to the related art.

### DETAILED DESCRIPTION

Hereinafter, example embodiments of the present disclosure are described with reference to the accompanying drawings. The present disclosure may, however, be exemplified in many different forms and should not be construed as being limited to the specific example embodiments set forth herein. In addition, example embodiments of the present disclosure may be provided for a more complete description of the present disclosure to those skilled in the art. Accordingly, the shapes and sizes of the elements in the drawings may be exaggerated for clarity of description, and elements denoted by the same reference numerals in the drawings may be the same elements.

Hereinafter, preferred example embodiments of the present disclosure will be described with reference to the accompanying drawings.

In the drawings, an X-direction may be defined as a first direction, a T-direction, or a thickness direction, a Y-direction may be defined as a second direction, an L-direction, or a length direction, and a Z-direction may be defined as a third direction, a W-direction, or a width direction.

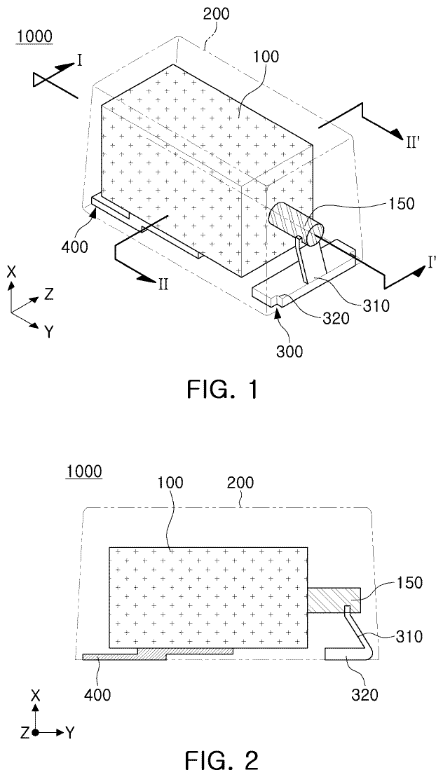

FIG. 1 is a perspective view of a tantalum capacitor according to the present disclosure.

FIG. 2 is a diagram illustrating a tantalum capacitor viewed in a third direction according to the present disclosure.

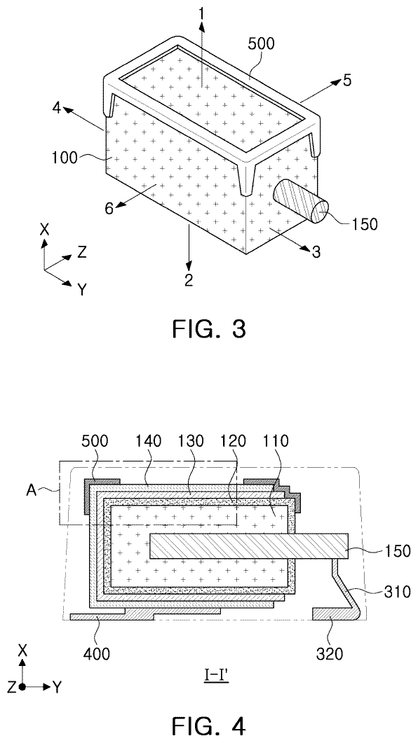

FIG. 3 is a perspective view of a tantalum body and a coating layer of a tantalum capacitor according to the present disclosure.

FIG. 4 is a cross-sectional view taken along line I-I′ of FIG. 1.

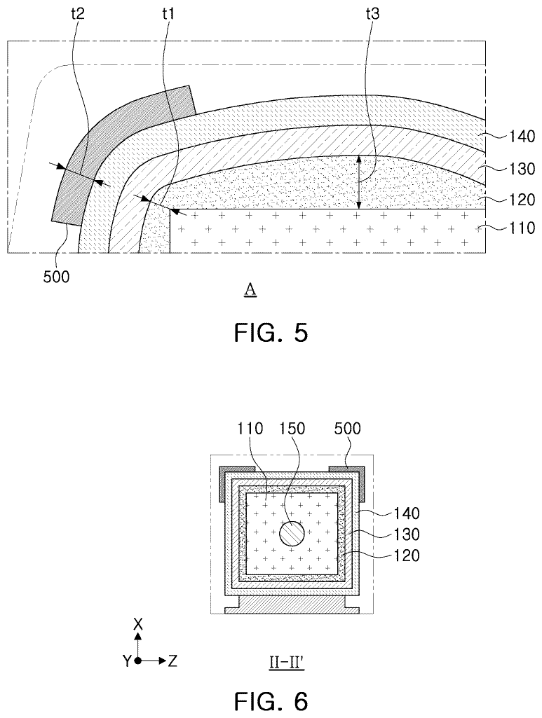

FIG. 5 is an enlarged view of portion “A” of FIG. 4.

FIG. 6 is a cross-sectional view taken along line II-II′ of FIG. 1.

Referring to FIGS. 1 to 3, a tantalum capacitor 1000 according to the present example embodiment may include a tantalum body 100 including a tantalum element body 110 including tantalum particles, and a conductive polymer layer 120 disposed on the tantalum element body 110, the tantalum body 100 having a first surface 1, a second surface 2 opposing the first surface 1 in a first direction (X-direction), and a plurality of side surfaces 3, 4, 5, and 6 connecting the first surface 1 and the second surface 2 to each other, a molded portion 200 surrounding the tantalum body 100, and a coating layer 500 disposed on an edge of the first surface of the tantalum body 100 and at least a portion of an edge on which the first surface 1 and a plurality of side surfaces meet each other. The tantalum capacitor 1000 according to the present example embodiment may further include an anode lead frame 300 and a cathode lead frame 400.

The tantalum body 100 may have the tantalum wire 150 exposed in the second direction (Y-direction) of the body 100. Here, the tantalum wire 150 may pass through at least a portion of the tantalum element body 110 in the second direction (Y-direction). The tantalum wire 150 may be inserted into and installed in a mixture of tantalum particles and a binder to be off-centered before the mixture of the tantalum particles and the binder is compressed. That is, the tantalum body 100 may be manufactured by insertedly installing the tantalum wire 150 in tantalum powder mixed with the binder, forming a tantalum element having a desired size, and then sintering the tantalum element in a high temperature and high vacuum (10⁻⁵ torr or less) atmosphere for about 30 minutes.

The tantalum body 100 may have the first surface 1 and the second surface 2 opposing each other in the first direction (X-direction), and the plurality of side surfaces (third to sixth surfaces) connecting the first surface 1 and the second surface 2 each other. Specifically, the third and fourth surfaces 3 and 4 may oppose each other in the second direction (Y-direction), and may connect the first surface 1 and the second surface 2 to each other, and the fifth and sixth surfaces 5 and 6 may oppose each other in the third direction (Z-direction), and may connect the first surface 1 and the second surface 2 to each other.

The first surface 1 and the second surface 2 may be an upper surface and a lower surface of the tantalum body 100 based on FIGS. 1 and 2, respectively, but the present disclosure is not limited thereto.

Here, the first direction (X-direction), the second direction (Y-direction), and the third direction (Z-direction) may be perpendicular to each other. In the following description, each of the first direction (X-direction), the second direction (Y-direction), and the third direction (Z-direction) may represent both directions. For example, the first direction (X-direction) may include both an upward direction and a downward direction based on the drawings.

The molded portion 200 may cover the tantalum body 100, and may be formed to expose one surface of a first connection portion 320 of the anode lead frame 300 and one surface of the anode lead frame 400 to be described below.

The molded portion 200 of the tantalum capacitor according to the present disclosure may be formed by transfer-molding a resin, such as an epoxy molding compound (EMC) or the like, to surround the tantalum body 100. The molded portion 200 may serve to protect the tantalum wire 150 and the tantalum body 100 from the outside.

The anode lead frame 300 may be connected to the tantalum wire 150 to serve as a terminal when mounted on a board. The anode lead frame 300 may include the first connection portion 320, and a first bent portion 310, and the first bent portion 310 may be inclined toward the tantalum body 100 with respect to the first connection portion 320. The first connection portion 320 of the anode lead frame 300 may be exposed to a lower surface of the molded portion 200. The first connection portion 320 may be exposed to the lower surface of the molded portion 200 to serve as a terminal when mounted on a board. In this case, the first connection portion 320 may be spaced apart from the tantalum body 100, and may function as an anode of the tantalum capacitor 1000 according to the present disclosure. To this end, the anode lead frame 300 may be formed of a conductive metal such as a nickel/iron alloy.

The cathode lead frame 400 may be connected to the tantalum body 100 to serve as a terminal when mounted on a board. The cathode lead frame 400 may be spaced apart from the anode lead frame 300 to be parallel to the anode lead frame 300 in the second direction (Y-direction). The cathode lead frame 400 may be exposed to the lower surface of the molded portion 200. The cathode lead frame 400 may be exposed to the lower surface of the molded portion 200 to serve as a terminal when mounted on a board, and may function as a cathode of the tantalum capacitor 1000 according to the present disclosure. To this end, the cathode lead frame 400 may be formed of a conductive metal such as a nickel/iron alloy.

Although not illustrated in the drawings, the tantalum capacitor according to an example embodiment of the present disclosure may further include a conductive adhesive layer to bond the cathode lead frame 400 and the tantalum body 100 to each other. The conductive adhesive layer may be formed by, for example, coating and curing a certain amount of a conductive adhesive including an epoxy-based thermosetting resin and conductive metal particles such as silver (Ag), but the present disclosure is not limited thereto.

FIG. 4 is a cross-sectional view taken along line I-I′ of FIG. 1.

Referring to FIG. 4, the tantalum body 100 of the tantalum capacitor 1000 according to an example embodiment of the present disclosure may include the tantalum element body 110 formed by sintering a molded body including metal particles, a conductive polymer layer 120 disposed on an upper portion of the tantalum element body 110, a carbon layer 130 disposed on the conductive polymer layer 120, and a silver (Ag) layer 140 disposed on the carbon layer 130.

The tantalum capacitor may further include the tantalum wire 150 having an insertion region positioned on the inside of the tantalum element body 110, and a non-insertion region positioned on the outside of the tantalum element body 110.

The tantalum element body 110 may be formed by sintering a molded body including metal particles and a binder.

Specifically, the tantalum element body 110 may be manufactured by mixing metal particles, a binder, and a solvent at a predetermined ratio, stirring mixed power, compressing the mixed particles to form the mixed particles having a rectangular parallelepiped shape, and then sintering the same under high temperature and high vibrations.

The metal particles is not limited as long as it may be used in the tantalum element body 110 of the tantalum capacitor 1000 according to an example embodiment of the present disclosure, and may be tantalum (Ta) particles. However, the present disclosed is not limited thereto, the metal particles may be one or more selected from the group consisting of aluminum (Al), niobium (Nb), vanadium (V), titanium (Ti), and zirconium (Zr), and accordingly, an aluminum element body, a niobium element body, or the like may also be used, instead of a tantalum element body.

The binder is not limited, and may be, for example, a cellulose-based binder.

The cellulose-based binder may be one or more selected from the group consisting of nitrocellulose, methyl cellulose, ethyl cellulose, and hydroxy propyl cellulose.

In addition, the tantalum wire 150 may be inserted into and installed in the mixed particles to be off-centered, before the mixed particles is compressed.

According to an example embodiment of the present disclosure, a dielectric oxide layer may be formed on the tantalum element body 110, as an insulating layer. That is, the dielectric oxide layer may be formed by growing an oxide film (Ta₂O₅) on a surface of the tantalum element body 110 through a formation process using an electrochemical reaction. Here, the dielectric oxide layer may change the tantalum element body 110 into a dielectric. In addition, the conductive polymer layer 120 having a negative polarity may be coated and formed on the dielectric oxide layer.

The conductive polymer layer 120 is not limited, and may include, for example, a conductive polymer.

Specifically, the conductive polymer may be formed using chemical polymerization or electrolytic polymerization using 3,4-ethylenedioxythiophene (EDOT), a pyrrole monomer, or polypyrrole, and may then be formed on an external surface of the tantalum element body 110 formed as an insulating layer, as a cathode layer having a conductive polymer cathode.

That is, the conductive polymer layer 120 may be formed using a polymer slurry, and the polymer slurry may include at least one of polypyrrole, polyaniline, or 3,4-ethylenedioxythiophene (EDOT). In addition, the conductive polymer layer 120 may include poly(3,4-ethylenedioxythiophene):poly(styrenesulfonate) (PEDOT:PSS). PEDOT:PSS may be prepared by oxidative polymerization of EDOT using polystyrene sulfonate (PSS) as a template for balancing an electric charge.

As will be described below, when a thickness of an edge portion of the conductive polymer layer 120 is denoted by t1, t1 may be 5 μm or more and 20 μm. A thickness (t3) of a central portion of the conductive polymer layer 120 may be greater than the thickness (t1) of the edge portion of the conductive polymer layer 120, and may be greater than 20 μm and less than or equal to 60 μm.

The carbon layer 130 may be laminated on the conductive polymer layer 120, and may be laminated by dissolving carbon particles in an organic solvent including an epoxy resin, impregnating the tantalum element body 110 in the solution in which the carbon particles are dissolved, and then, perform drying thereon at a predetermined temperature to volatilize the organic solvent.

In addition, the carbon layer 130 may serve to prevent silver (Ag) ions from passing therethrough.

Then, the silver (Ag) layer 140, formed of silver (Ag) paste, may be included on an upper surface of the carbon layer 130.

The silver (Ag) layer 140 may be laminated on the outside of the carbon layer 130 to improve conductivity.

In addition, the silver (Ag) layer 140 may improve conductivity with respect to a polarity of a cathode layer, thereby facilitating electrical connection for polarity transfer.

The tantalum capacitor according to the present disclosure may include the coating layer 500.

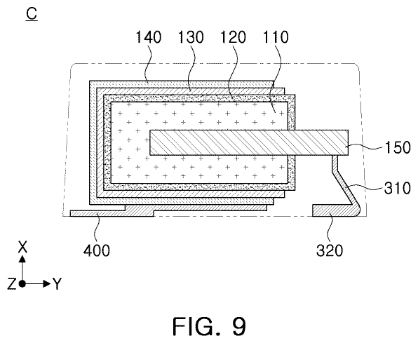

FIG. 9 is a cross-sectional view of a tantalum capacitor according to the related art. The tantalum capacitor according to the related art, not including a coating layer, may have an interface defect occurring due to insufficient bonding force secured between a tantalum body and a molded portion. Vapor pressure may permeate into a capacitor through an interface occurring in a high temperature and humidity environment, such that a component may have degraded reliability (hereinafter, referred to as a moisture absorption defect).

In addition, when a conductive polymer is coated on a sintered tantalum element body, a film may have a non-uniform thickness, such that the tantalum capacitor may have degraded reliability. Specifically, a conductive polymer layer formed on an edge portion of a tantalum element body may be thinner that of a central portion of the tantalum element body, and thus the tantalum capacitor may be vulnerable to internal stress when a tantalum element is subject to hygroscopic swelling and thermal expansion. Referring to FIG. 5, the conductive polymer layer 120 may have a thickness gradually increasing from the edge portion to the central portion. When the thickness of the edge portion of the conductive polymer layer 120 is denoted by t1, t1 may be 5 μm or more and 20 μm or less. Conversely, the thickness (t3) of the central portion of the conductive polymer layer 120 may be greater than the thickness (t1) of the edge portion, and t3 may be greater than 20 μm and less than or equal to 60 μm.

An edge portion of the conductive polymer layer 120 may refer to a conductive polymer layer disposed on an edge on which a plurality of surfaces of the tantalum element body 110 meet each other. In this case, an edge of the tantalum element body 110 may not be referred to as a simple line, but may be collectively referred to a region adjacent to the edge. That is, the edge portion of the conductive polymer layer 120 may refer to the conductive polymer layer 120 disposed on the edge of the tantalum element body 110 and the region adjacent thereto.

A central portion of the conductive polymer layer 120 may refer to a conductive polymer layer disposed on the tantalum element body 110 excluding the edge portion.

The tantalum capacitor 1000 according to the present disclosure may include a coating layer 500 disposed on the tantalum body 100.

The tantalum capacitor according to the present disclosure may strengthen an interface between the tantalum body and the molded portion to lower a moisture absorption rate, thereby securing reliability. In addition, when an internal element expands due to moisture permeation and heat, the tantalum capacitor may have enhanced characteristics against internal stress.

The coating layer 500 of the tantalum capacitor according to the present disclosure will be described in detail with reference to FIGS. 3 to 6. FIG. 3 is a perspective view of a tantalum body and a coating layer of a tantalum capacitor according to the present disclosure.

The coating layer 500 may be disposed on at least a portion of an edge on which the first surface 1 and the plurality of side surfaces of the tantalum body 100 meet each other. In addition, at least a portion of the coating layer 500 may also be disposed on an edge on which the plurality of side surfaces meet each other.

That is, the coating layer 500 may be formed on an edge of an upper surface (the first surface 1) of the tantalum body 100 and an adjacent edge thereof using a screen-printing process or jetting process to be described below.

The coating layer 500 may be disposed between the tantalum body 100 and the molded portion 200 to sufficiently secure interfacial bonding force, thereby preventing a moisture absorption failure. In addition, as described above, when an internal element expands due to moisture permeation and heat, an edge of the tantalum body 100, vulnerable to internal stress, may be strengthened.

The coating layer 500 may be disposed on the silver (Ag) layer 140 to be in contact with the silver (Ag) layer 140. That is, the coating layer 500 may be disposed between the silver (Ag) layer 140 and the molded portion 200.

The conductive polymer layer 120 on the edge portion of the tantalum element body may be thinner that of the central portion of the tantalum element body, and thus an edge portion of the tantalum body may be vulnerable to internal stress when a tantalum element is subject to hygroscopic swelling and thermal expansion. Accordingly, in the tantalum capacitor according to the present disclosure, a coating layer 500 having a specific thickness may be formed on the edge portion to compensate for the small thickness of the conductive polymer layer 120 formed on the edge portion of the tantalum element body.

When a thickness of the coating layer 500 is denoted by t2, t2 may be 0.5 μm or more and 80 μm or less.

A sum (t1+t2) of the thickness (t1) of the edge portion of the conductive polymer layer and the thickness (t2) of the coating layer 500 may satisfy 5.5 μm or more and 100 μm or less.

Table 1 below indicates a reliability defect (for moisture absorption and stress) and an exterior defect when the sum (t1+t2) of the thickness (t1) of the edge portion of the conductive polymer layer and the thickness (t2) of the coating layer 500 varies.

TABLE 1

| | t1 + | Reliability | Exterior |
|---|---|---|---|
| No. | t2[μm] | defect | defect |
| Comparative | 5 | Poor | Good |
| Example 1 | | | |
| Experimental | 5.5 | Good | Good |
| Example 1 | | | |
| Experimental | 20 | Good | Good |
| Example 2 | | | |
| Experimental | 35 | Good | Good |
| Example 3 | | | |
| Experimental | 50 | Good | Good |
| Example 4 | | | |
| Experimental | 65 | Good | Good |
| Example 5 | | | |
| Experimental | 80 | Good | Good |
| Example 6 | | | |
| Experimental | 100 | Good | Good |
| Example 7 | | | |
| Comparative | 100~120 | Good | Poor |
| Example 2 | | | |

Referring to Table 1 above, when the sum (t1+t2) is less than 5.5 μm (Comparative Example 1), vapor pressure may permeate through the edge of the tantalum body. When an internal element expands due to moisture permeation and heat, the internal element may become vulnerable to internal stress. In addition, when the sum (t1+t2) is greater than 100 μm (Comparative Example 2), the tantalum capacitor may have good reliability. However, the thickness of the coating layer 500 may excessively increase, such that a portion of a component may be exposed to the exterior.

When the sum (t1+t2) is 5.5 μm or more and 100 μm or less, it may be possible to prevent an exterior defect of the tantalum capacitor while improving reliability against moisture absorption and stress.

Referring to FIG. 5, a method of measuring thicknesses of the conductive polymer layer 120 and the coating layer 500 will be described.

The tantalum element body 110 may have a hexahedral shape. In a cross-sectional view illustrated in FIG. 5, a cross-section thereof may have a rectangular shape. The thickness (t1) of the edge portion of the conductive polymer layer 120 may be obtained by measuring a shortest straight distance with respect to a vertex of the tantalum element body 110 having a hexahedral shape. However, the present disclosure is not limited thereto, and the thickness (t1) may be obtained by extending a bisector of an angle between two surfaces of the tantalum element body 110 and measuring a length of the conductive polymer layer on the bisector. The thickness (t3) of the central portion of the conductive polymer layer 120 may refer to a thickness at a ½ point of the tantalum element body 110 in the second direction (Y-direction) in the cross-sectional view illustrated in FIG. 5.

The thickness (t2) of the coating layer 500 may be inferred to measure a thickness of the conductive polymer layer 120. As an example, the thickness of the coating layer may be measured in a direction of a shortest linear distance with respect to the vertex of the tantalum element body 110, and the thickness of the coating layer on the bisector may be measured by extending a bisector of an angle formed between two surfaces of the tantalum element body 110.

A thickness and arrangement of the coating layer 500 may be confirmed using the following method. A cross-section of the tantalum capacitor in the first direction (X-direction)—the second direction (Y direction) may be polished to a depth of about ½ in the third direction (Z-direction) to collect a cross-section sample illustrate in FIG. 5. When the collected cross-section sample is observed using a scanning electron microscope (SEM) at a magnification of 500 to 20000, the thickness and arrangement of the coating layer may be confirmed in an interface region with the molded portion.

The coating layer 500 may not be disposed on at least a portion of the first surface 1 of the tantalum body 100. Specifically, the coating layer 500 may not be disposed at the center of the first surface 1. As described above, the conductive polymer layer 120 on the central portion of the tantalum element body 110 may be thicker than that on the edge portion of the tantalum element body 110. That is, the conductive polymer layer 120 on the central portion may have a relatively large thickness, such that the coating layer 500 may not be disposed, as necessary. Accordingly, it may be possible to prevent an exterior defect caused by excessive enlargement of the tantalum body.

At least a portion of the first surface 1 of the tantalum body 100 may be in direct contact with the molded portion 200. As described above, the coating layer 500 may not be disposed at the center of the first surface 1 of the tantalum body 100, and the center of the first surface 1 of the tantalum body 100 may be in contact with the molded portion 200.

Similarly, the coating layer 500 may not be disposed on a plurality of side surfaces of the tantalum body 100, that is, at least a portion of the third to sixth surfaces 3, 4, 5, and 6. Specifically, the coating layer 500 may not be disposed at the center of the third to sixth surfaces 3, 4, 5, and 6. That is, at least a portion of each of the third to sixth surfaces 3, 4, 5, and 6 of the tantalum body 100 may be in contact with the molded portion 200.

The coating layer 500, a material having high ductility, may include a material that is not destroyed even when a force exceeding an elastic limit is applied. Specifically, the coating layer 500 may include at least one of an epoxy resin, polyimide, silicone, and silicone rubber.

The coating layer 500 may be formed on an edge of an upper surface (first surface 1) of the tantalum body 100 of the tantalum capacitor in a semi-finished product state and an edge adjacent thereto, using a screen-printing process or ink jetting process. However, the present disclosure is not limited thereto, and may also be formed using dipping, spraying, or deposition. Here, the semi-finished product state may collectively refer to a state before the molded portion 200, forming the exterior of the tantalum capacitor, is formed.

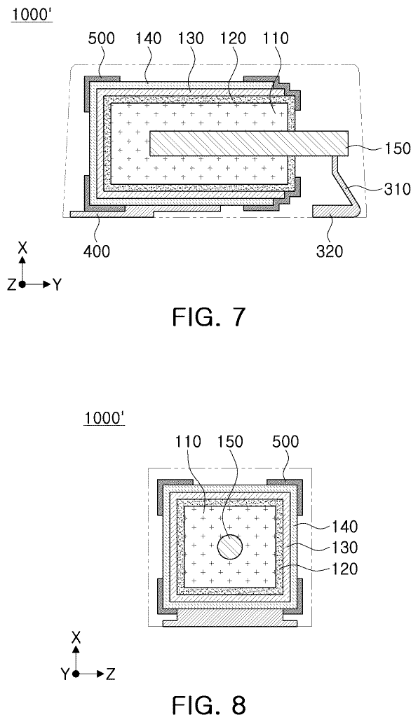

Hereinafter, a modified example 1000′ of the tantalum capacitor according to the present disclosure will be described with reference to FIGS. 7 and 8.

FIG. 7 is a modification of a tantalum capacitor according to the present disclosure, and is a cross-sectional view corresponding to FIG. 3. FIG. 8 is a modification of a tantalum capacitor according to the present disclosure, and is a cross-sectional view corresponding to FIG. 5.

In a modification 1000′ of the tantalum capacitor according to the present disclosure, a coating layer 500 may also be disposed at least a portion of an edge on which the second surface 2 of a tantalum body 100 and a plurality of side surfaces meet each other. That is, the coating layer 500 may be formed on an edge of a lower surface (second surface 2) of a tantalum body 100 and an edge adjacent thereto.

In the modification 1000′ of the tantalum capacitor according to the present disclosure, the coating layer 500 may be disposed on a lower portion of the tantalum body 100, further improving reliability against moisture absorption and stress.

At least a portion of the second surface 2 of the tantalum body 100 may be in contact with a molded portion 200. A conductive polymer layer 120 may be formed on a central portion of the second surface 2 of the tantalum body 100 to be relatively thick, such that the coating layer 500 may not be disposed.

While example embodiments have been shown and described above, it will be apparent to those skilled in the art that modifications and variations could be made without departing from the scope of the present disclosure as defined by the appended claims.

What is claimed is:

1. A tantalum capacitor comprising:
a tantalum body including a tantalum element body including tantalum particles and a conductive polymer layer disposed on the tantalum element body, the tantalum body having a first surface, a second surface opposing the first surface in a first direction, and a plurality of side surfaces connecting the first surface and the second surface to each other;
a molded portion surrounding the tantalum body; and
a coating layer disposed on at least a portion of an edge on which the first surface of the tantalum body and the plurality of side surfaces meet each other,
when a thickness of an edge portion of the conductive polymer layer is denoted by t1 and a thickness of the coating layer is denoted by t2, a sum of t1 and t2 satisfies 5.5 μm or more and 100 μm or less.

2. The tantalum capacitor of claim 1, wherein the thickness (t1) of the edge portion of the conductive polymer layer satisfies 5 μm or more and 20 μm or less.

3. The tantalum capacitor of claim 1, wherein the thickness (t2) of the coating layer t2 is 0.5 μm or more and 80 μm or less.

4. The tantalum capacitor of claim 1, wherein the coating layer includes at least one of an epoxy resin, polyimide, silicone, and silicone rubber.

5. The tantalum capacitor of claim 1, wherein at least a portion of the first surface of the tantalum body is in contact with the molded portion.

6. The tantalum capacitor of claim 5, wherein at least a portion of each of the plurality of side surfaces of the tantalum body is in contact with the molded portion.

7. The tantalum capacitor of claim 1, wherein the coating layer is also disposed on at least a portion of an edge on which the plurality of side surfaces of the tantalum body meet each other.

8. The tantalum capacitor of claim 1, wherein the coating layer is also disposed on at least a portion of an edge on which the second surface and the plurality of side surfaces of the tantalum body meet each other.

9. The tantalum capacitor of claim 8, wherein at least a portion of the second surface of the tantalum body is in contact with the molded portion.

10. The tantalum capacitor of claim 1, wherein the tantalum body has a tantalum wire extending in a second direction crossing the first direction.

11. The tantalum capacitor of claim 10, wherein the tantalum wire extends from one of the plurality of side surfaces.

12. The tantalum capacitor of claim 10, further comprising:
an anode lead frame connected to the tantalum wire; and
a cathode lead frame spaced apart from the anode lead frame, the cathode lead frame connected to the tantalum body.

13. The tantalum capacitor of claim 12, wherein the cathode lead frame is disposed on the second surface.

14. The tantalum capacitor of claim 1, wherein the tantalum body further includes:
a carbon layer disposed on the conductive polymer layer; and
a silver (Ag) layer disposed on the carbon layer, and
the coating layer is in contact with the silver (Ag) layer.

15. A tantalum capacitor comprising:
a tantalum body including a tantalum element body including tantalum particles and a conductive polymer layer disposed on the tantalum element body, the tantalum body having a first surface, a second surface opposing the first surface in a first direction, and a plurality of side surfaces connecting the first surface and the second surface to each other;
a molded portion surrounding the tantalum body; and
a coating layer disposed on at least a portion of an edge on which the first surface of the tantalum body and the plurality of side surfaces meet each other,
wherein at least a portion of the first surface of the tantalum body is in contact with the molded portion.

16. The tantalum capacitor of claim 15, wherein a thickness (t1) of an edge portion of the conductive polymer layer satisfies 5 μm or more and 20 μm or less.

17. The tantalum capacitor of claim 15, wherein a thickness (t2) of the coating layer is 0.5 μm or more and 80 μm or less.

18. The tantalum capacitor of claim 15, wherein the coating layer is disposed on at least a portion of an edge on which the second surface of the tantalum body and the plurality of side surfaces meet each other, and
at least a portion of the second surface of the tantalum body is in contact with the molded portion.

19. The tantalum capacitor of claim 15, wherein at least a portion of each of the plurality of side surfaces of the tantalum body is in contact with the molded portion.

20. The tantalum capacitor of claim 15, wherein the tantalum body has a tantalum wire extending from one of the plurality of side surfaces, and
the tantalum capacitor further comprises:
an anode lead frame connected to the tantalum wire; and
a cathode lead frame spaced apart from the anode lead frame, the cathode lead frame disposed on the second surface and connected to the tantalum body.
